(19) United States
(12) Patent Application Publication
(10) Pub. No.: US 2023/0410118 A1
(43) Pub. Date: Dec. 21, 2023

(54) TRANSACTION PROCESSING SYSTEM, TRANSACTION PROCESSING APPARATUS, AND INFORMATION PROCESSING METHOD

(71) Applicant: Toshiba Tec Kabushiki Kaisha, Tokyo (JP)

(72) Inventors: Yuji HAYASHI, Tagata Shizuoka (JP); Takashi IIZUKA, Izunokuni Shizuoka (JP)

(21) Appl. No.: 18/183,894

(22) Filed: Mar. 14, 2023

(30) Foreign Application Priority Data
Jun. 17, 2022 (JP) 2022-097939

(51) Int. Cl. G06Q 20/40; G06Q 20/20

(52) U.S. Cl. CPC G06Q 20/407; G06Q 20/209

(57) ABSTRACT

A transaction processing system provides for improved item return and exchange processing for retail stores and the like. The system includes a point-of-sale terminal configured to generate transaction data for a customer transaction and perform processing operations related to returns and exchanges and a server. The server includes a storage unit storing transaction data for previous customer transactions. The transaction data for the previous customer transactions includes a list of items in the transaction. A processor in the server selects the transaction data of one of the previous customer transactions based on an input of a transaction identifier from the point-of-sale terminal, cancels the selected transaction data, generates registration data for a new customer transaction with the list from the now-cancelled transaction data, updates the new registration data according to instructions from the point-of-sale terminal, and stores the updated registration data as new transaction data.

### CROSS-REFERENCE TO RELATED APPLICATION

This application is based upon and claims the benefit of priority from Japanese Patent Application No. 2022-097939, filed Jun. 17, 2022, the entire contents of which are incorporated herein by reference.

### FIELD

Embodiments described herein relate generally to a transaction processing system for retail sales transactions, a transaction processing apparatus for such a system, and an information processing method for such a transaction processing apparatus.

### BACKGROUND

In a point-of-sale (POS) system, a journal file, in which transaction data for transactions performed over some period, is generated and stored, the content of one or more transactions included in the journal file may sometimes be corrected/changed after the initial completion of the transaction.

For example, after payment for a transaction has been completed, a customer may subsequently request to return some or all of purchased commodities involved in the transaction. In such a case, the journal file related to the transaction can be read and updated with the revised transaction data to exclude the returned commodities from the accumulated transaction data.

However, in a transaction processing system of the related art, the registration of a new commodity at the same time as the customer return request must be registered (treated) as an entirely new transaction.

Therefore, for example, when the return is performed for a purpose of exchange with another commodity, an operator needs to first perform an operation of updating the transaction data related to the past transaction as described above, and then separately perform a registration operation related to a new transaction for the outgoing exchanged commodity.

The burden on the POS operator related to the correction of the past transaction is thus high and it would be desirable reduce such burdens.

### BRIEF DESCRIPTION OF THE DRAWINGS

FIG. 1 is a block diagram illustrating a schematic configuration of a transaction processing system and main circuit configurations of a POS terminal device and a POS server.

FIG. 2 is a flowchart illustrating a processing procedure of correction processing.

FIG. 3 is a diagram illustrating an example of a transaction confirmation screen.

FIG. 4 is a diagram schematically illustrating a structure of a data record included in registration data.

FIG. 5 is a diagram illustrating an example of a registration screen.

FIG. 6 is a flowchart illustrating a processing procedure for updating the registration data.

FIG. 7 is a diagram illustrating an example of an updated registration screen.

FIG. 8 is a diagram illustrating an example of a receipt.

### DETAILED DESCRIPTION

In general, according to certain embodiments, a transaction processing system, a transaction processing apparatus, and an information processing method for reducing a burden on a salesclerk or the like related to correction of a past transaction are provided. Such examples provide a technological solution to existing problems in the systems, apparatuses, and processing methods of the related art.

According to an embodiment, a transaction processing system for improved item return and exchange processing includes a server and a point-of-sale terminal configured to generate transaction data for a customer transaction and perform processing operations related to returns and exchanges. The server includes a storage unit configured to store transaction data for a plurality of previous customer transactions. The transaction data for each previous customer transaction includes a list of items included in the customer transaction. A processor in the server is configured to: select the transaction data of one of the plurality of previous customer transactions in the storage unit based on an input of a transaction identifier from the point-of-sale terminal; cancel the selected transaction data; generate registration data corresponding to a new customer transaction, the registration data including the list of items included in the customer transaction corresponding the cancelled selected transaction data; update the generated registration data according to an operation instruction from the point-of-sale terminal; and store the updated registration data as new transaction data in the storage unit.

According to another embodiment, a transaction processing system includes a storage unit, a selection unit, a cancellation unit, a generation unit, an update unit, and a history management unit. The storage unit stores a plurality of pieces of transaction data in which a list of items that are targets of a transaction performed in past is represented. The selection unit selects one of the plurality of pieces of transaction data stored in the storage unit. The cancellation unit cancels the past transaction selected by the selection unit. In this context, “cancels” means nullify or otherwise indicate the entire previous transaction should be considered as invalidated for the purposes of tracking or managing the list of items purchased in the prior (now-cancelled) transaction. The generation unit generates registration data representing a list with all the items that were the transaction targets in the list of items in the selected (now-cancelled) transaction data. The update unit updates the generated registration data according to an instruction from an operator of a point-of-sale terminal or the like at which a return or exchange (“correction operation”) related to the past transaction is being performed. The history management unit stores, in the storage unit, new transaction data in which the list corresponding to the updated registration data with the items are now included as a new transaction separate from the (now-cancelled) past transaction.

Hereinafter, certain example embodiments will be described with reference to the drawings. A transaction processing system including a POS terminal device and a POS server will be described as one non-limiting example.

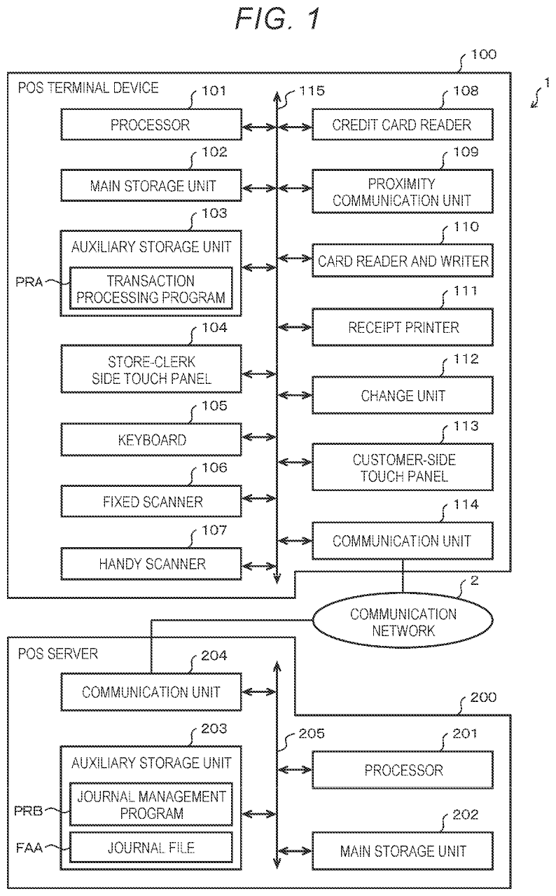

FIG. 1 is a block diagram illustrating a schematic configuration of a transaction processing system 1 along with basic configurations of a POS terminal device 100 and a POS server 200 included in this example system. The POS terminal device 100 and the POS server 200 can communicate with each other via a communication network 2.

The POS terminal device 100 performs processing associated with selling commodities (items) to customers in a store. That is, the POS terminal device 100 is an example of a transaction processing apparatus that performs processing of a commercial transaction.

The POS terminal device 100 is a so-called face-to-face type, and a store clerk is mainly an operator of the POS terminal device 100. The POS terminal device 100 is installed in the store to face a workspace of the store clerk. Normally, the customer waits in a waiting space defined separately from the workspace. Therefore, in the following description, a workspace side and a waiting space side of the POS terminal device 100 are referred to as a store clerk side and a customer side, respectively.

The POS terminal device 100 includes a processor 101, a main storage unit 102, an auxiliary storage unit 103, a store-clerk-side touch panel 104, a keyboard 105, a fixed scanner 106, a handy (handheld) scanner 107, a credit card reader 108, a proximity communication unit 109, a card reader and writer 110, a receipt printer 111, a change unit 112, a customer-side touch panel 113, a communication unit 114, and a transmission path 115. The processor 101, the main storage unit 102, the auxiliary storage unit 103, the store-clerk-side touch panel 104, the keyboard 105, the fixed scanner 106, the handy scanner 107, the credit card reader 108, the proximity communication unit 109, the card reader and writer 110, the receipt printer 111, the change unit 112, the customer-side touch panel 113, and the communication unit 114 are connected to the transmission path 115.

The processor 101, the main storage unit 102, and the auxiliary storage unit 103 are connected by the transmission path 115 for executing information processing related to control of the POS terminal device 100.

The processor 101 corresponds to a central part of a computer. The processor 101 executes information processing based on an operating system, middleware, and information processing programs such as an application program that are stored in the main storage unit 102 and the auxiliary storage unit 103 to control units of the POS terminal device 100 for implementing various functions of the POS terminal device 100.

The main storage unit 102 includes a read-only memory area and a rewritable memory area. The main storage unit 102 stores a part of the information processing programs in the read-only memory area. In addition, the main storage unit 102 may store data required for the processor 101 to execute processing of controlling the units in the read-only memory area or the rewritable memory area. The main storage unit 102 uses the rewritable memory area as a work area for the processor 101.

The auxiliary storage unit 103 can be one or more storage devices such as an electric erasable programmable read-only memory (EEPROM), a hard disc drive (HDD), and a solid state drive (SSD). The auxiliary storage unit 103 stores data used by the processor 101 in executing various types of information processing and data generated by the processing in the processor 101. The auxiliary storage unit 103 may store the information processing programs. In the present embodiment, the auxiliary storage unit 103 stores a transaction processing program PRA. The transaction processing program PRA is an application program with software instructions describing a processing procedure related to processing a transaction.

The store-clerk-side touch panel 104 is provided facing the store clerk side. The store-clerk-side touch panel 104 displays a screen for presenting information to the store clerk. In addition, the store-clerk-side touch panel 104 receives an instruction by a touch operation on the screen by the store clerk.

The keyboard 105 is provided with keys such that the operation by the store clerk from the store clerk side is easy. The keyboard 105 receives the instruction (input operations) of the store clerk by the pressing of these keys.

The fixed scanner 106 includes a reading window facing the store clerk side. The fixed scanner 106 captures an image of a commodity held in front of the reading window and recognizes, by image processing, barcode information represented by a barcode on the commodity. Then, the fixed scanner 106 outputs the barcode information to the processor 101. The fixed scanner 106 can also be or incorporate a well-known device of a type that optically reads the barcode by using reflection of a laser light. In addition, the fixed scanner 106 can also or instead be a type for specifying the commodity by using an object recognition technique.

The handy scanner 107 is used by being held in a hand of the store clerk, and optically reads the barcode facing a reading port. The handy scanner 107 outputs the barcode information to the processor 101.

The credit card reader 108 reads card information from a credit card. The proximity communication unit 109 performs proximity wireless communication with a nearby wireless tag and acquires data stored in the wireless tag. Further, the proximity communication unit 109 may write information to the wireless tag by the proximity wireless communication.

The card reader and writer 110 reads card data recorded on a predetermined card type such as a membership card or a prepaid card (e.g., a gift card or the like). The card reader and writer 110 may write data to the membership card.

The receipt printer 111 prints a receipt, a voucher, a sales slip, or the like on receipt sheet. The receipt printer 111 discharges the printed receipt sheet from a receipt discharge port to an outside.

The change unit 112 counts coins inserted from a coin insertion port and stores the coins in an internal storage box. The change unit 112 discharges the coins stored in the storage box to a coin tray via a coin discharge port. The change unit 112 counts (and identifies) banknotes inserted from a banknote insertion port and stores the banknotes in an internal storage box. The change unit 112 discharges the banknotes stored in the storage box from a banknote discharge port. The banknote discharge port holds the discharged bill(s) with just a part of the banknote is exposed to the outside so the banknotes do not fall or the like.

The customer-side touch panel 113 is provided facing the customer side. The customer-side touch panel 113 displays a screen for presenting information to the customer. In addition, the customer-side touch panel 113 receives an instruction by a touch operation on the screen by the customer.

The communication unit 114 performs communication processing for the processor 101 to transmit and receive various types of data to and from any device such as the POS server 200 via the communication network 2. A local area network (LAN) is typically used as the communication network 2. However, as the communication network 2, in addition to the LAN, the Internet, a virtual private network (VPN), a public communication network, a mobile communication network, and the like can be used alone or in combination as appropriate. As the communication unit 114, a known device conforming to a communication method of the communication network 2 can be used.

The transmission path 115 includes an address bus, a data bus, a control signal line, and the like. The transmission path 115 transmits data and signals transmitted and received between the connected units.

In general, the basic hardware of a POS terminal device 100 can be substantially similar to that of existing POS terminal devices though POS terminal device 100 should be considered as being specifically (re)configured by incorporation of special purpose software programs and the like as described. The POS terminal device 100 may be typically transferred with the transaction processing program PRA already stored in the auxiliary storage unit 103. However, the hardware of the POS terminal device 100 can be transferred separately from the transaction processing program PRA. The transaction processing program PRA may be later stored in the auxiliary storage unit 103 by user operation. Alternatively, the POS terminal device 100 may initially store an information processing program of a different version but of the same type as the transaction processing program PRA and the transaction processing program PRA be later stored (updated) in the auxiliary storage unit 103. The transaction processing program PRA can be transferred on a removable recording medium such as a magnetic disk, a magneto-optical disk, an optical disk, or a semiconductor memory, or by communication via a network. The transaction processing program PRA may be stored in the main storage unit 102 after transfer.

The POS server 200 includes a processor 201, a main storage unit 202, an auxiliary storage unit 203, a communication unit 204, and a transmission path 205. The processor 201 can communicate with the main storage unit 202, the auxiliary storage unit 203, and the communication unit 204 via the transmission path 205.

The processor 201, the main storage unit 202, and the auxiliary storage unit 203 are connected by the transmission path 205 to perform information processing of controlling the POS server 200.

The processor 201 executes information processing for controlling units of the POS server 200 to implement various functions of the POS server 200 in accordance with an operating system and/or information processing programs such as an application program.

The main storage unit 202 includes a read-only memory area and a rewritable memory area. The main storage unit 202 stores a part of the information processing programs in the read-only memory area. In addition, the main storage unit 202 may store data required for the processor 201 to execute processing of controlling the units in the read-only memory area or the rewritable memory area. The main storage unit 202 uses the rewritable memory area as a work area for the processor 201.

The auxiliary storage unit 203 can be or incorporate an EEPROM, an HDD, an SSD, or other known storage devices of various types. The auxiliary storage unit 203 stores data used by the processor 201 in executing various types of processing and data generated in the processing performed by the processor 201. The auxiliary storage unit 203 may store information processing programs. In the present embodiment, the auxiliary storage unit 203 stores a journal management program PRB. The journal management program PRB is an application program providing software instructions of a procedure of information processing for managing a journal file FAA that is separately stored in the auxiliary storage unit 203. The journal file FAA is a data file in which a plurality of pieces of transaction data representing contents of transactions performed in the past are accumulated. The transaction data provides at least a list of commodities which were processed as transaction targets. The transaction data also includes settlement information related to payment of the price of the items (commodities) in the transaction. Accordingly, the auxiliary storage unit 203 is one type of storage unit that stores a plurality of pieces of transaction data.

The communication unit 204 executes the communication processing for performing data communication via the communication network 2. In general, for the communication unit 204, any existing communication device or interface for Internet communications or the like can be used.

The transmission path 205 includes an address bus, a data bus, a control signal line, and the like, and handles data, control signals, and the like between the various connected units.

In general, the basic hardware configuration POS server 200 may correspond to a general-purpose server device, though it should be noted that such basic hardware should be considered as being re-configured in this context by special purpose software programs and the like. Transfer of the POS server 200 may typically be performed with the journal management program PRB already stored in the auxiliary storage unit 203 but usually without a journal file FAA being stored in the auxiliary storage unit 203 at this time. However, the journal management program PRB may be separately transferred from the hardware of the POS server 200. The journal management program PRB may be written into the auxiliary storage unit 203 according to an operation of an operator after hardware transfer or establishment. Alternatively, the hardware of the POS server 200 may be transferred along with a different (e.g., earlier) version of the journal management program PRB, which may then be updated by subsequent operations. The journal management program PRB can be transferred by being recorded on a removable recording medium such as a magnetic disk, a magneto-optical disk, an optical disk, or a semiconductor memory, or by communication via a network.

Next, an operation of the transaction processing system 1 will be described. The content of the processing to be described below is merely an example, and it is possible to change the order of some of the processing, omit some of the processing, modify some of the processing, and/or add another processing.

In the transaction processing system 1, registration processing of a commodity (a transaction commodity) for purchase in a transaction, accounting processing for calculation of the price of items (commodities) in the transaction and settlement of the transaction and journal management processing of managing the transaction data for completed transactions in association with a journal file FAA in the POS server 200 may be performed in a similar manner as found in existing transaction processing systems. The transaction processing system 1 is different from existing systems in that the processing related to correction of a content of a past transaction (e.g., in the context of a customer item return and exchange) represents a technological improvement over such systems that provides improvements in operator (e.g., sales clerk) and customer convenience.

In the POS terminal device 100, for example, when there is an instruction to perform a correction of a past transaction by a predetermined operation on the store-clerk-side touch panel 104 or the keyboard 105, the processor 101 starts information processing (hereinafter, referred to as correction processing) for the past transaction correction based on the execution of transaction processing program PRA.

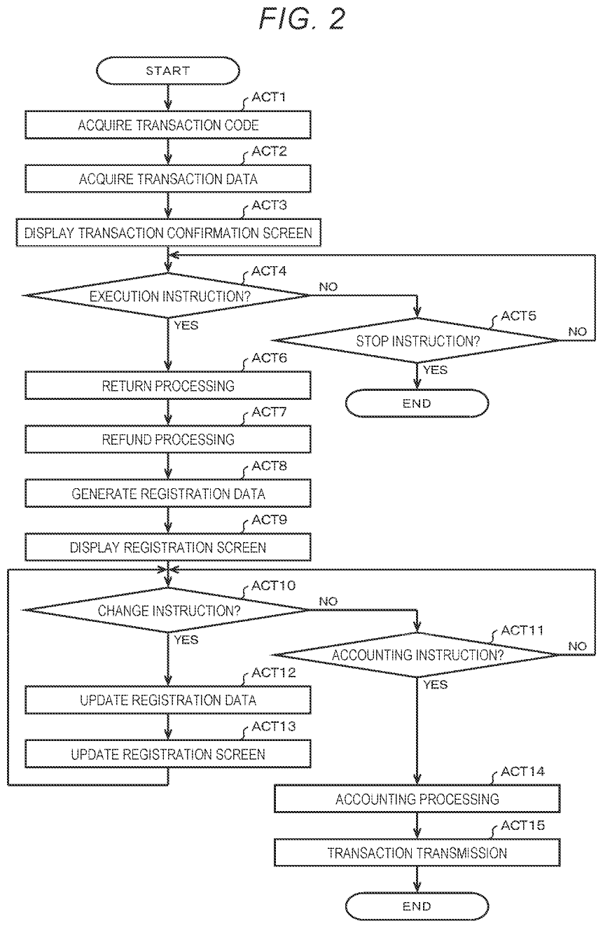

FIG. 2 is a flowchart illustrating a processing procedure of the correction processing.

In ACT 1, the processor 101 acquires a transaction code that is an identifier of a transaction that is the correction target.

For example, the store clerk that operates the POS terminal device 100 receives a request from the customer and receives the receipt previously issued for the transaction (target transaction) from the customer. In this context, the customer can be requesting to return some of the previously purchased commodities (transaction commodities), exchange a transaction commodity for another commodity of the same type, and/or purchase another commodity of a type different from the transaction commodity being returned. The store clerk uses the fixed scanner 106 or the handy scanner 107 to read a barcode including the transaction code on the receipt. Alternatively, the store clerk manually inputs a transaction code printed on the receipt by, for example, operating the store-clerk-side touch panel 104 or the keyboard 105. In any event, the processor 101 acquires the transaction code by one these operations.

In ACT 2, the processor 101 acquires the transaction data related to the transaction identified by the transaction code acquired in ACT 1. For example, the processor 101 requests the transaction data from the POS server 200 by notification including the acquired transaction code. When the processor 201 of the POS server 200 receives the request for the transaction data, the processor 201 extracts the transaction data associated with the notified transaction code in the journal file FAA, and transmits the extracted transaction data to the POS terminal device 100. Therefore, the processor 101 of the POS terminal device 100 acquires the transaction data from the POS server 200.

Here, according to the instruction of the store clerk, the processor 101 acquires transaction data for a specific transaction and functions as a selection unit by execution of the transaction processing program PRA.

In ACT 3, the processor 101 displays a transaction confirmation screen on the store-clerk-side touch panel 104. The transaction confirmation screen is a screen for allowing the store clerk to check and confirm the content of the acquired transaction data.

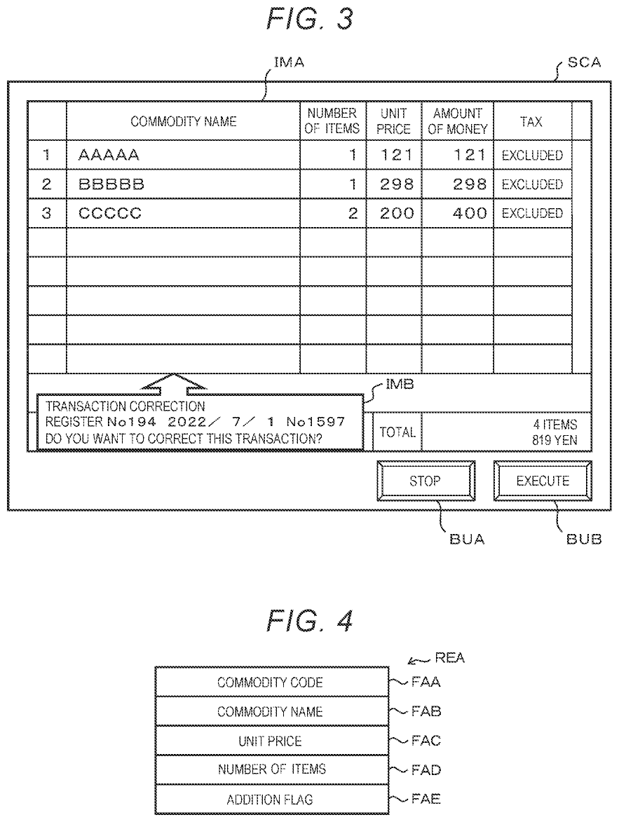

FIG. 3 is a diagram illustrating an example of a transaction confirmation screen SCA.

The transaction confirmation screen SCA displays images IMA and IMB and buttons BUA and BUB. The image IMA provides details of the content of the transaction. In FIG. 3, the image IMA represents a state where one commodity having a commodity name “AAAAA” and a unit price of 121 yen, one commodity having a commodity name “BBBBB” and a unit price of 298 yen, and two commodities having a commodity name “CCCCC” and a unit price of 200 yen are the transaction commodities. The image IMB can be superimposed on the image IMA, and provides a text message prompting the store clerk to confirm whether to execute correction on the transaction having content represented in the image IMA. The button BUA is a soft key for receiving an instruction to stop the correction. The button BUB is a soft key for receiving an instruction to execute the correction.

In ACT 4, the processor 101 checks whether the correction execution instruction has been received. If not, the processor 101 determines NO and proceeds to ACT 5.

In ACT 5, the processor 101 checks whether the stop instruction has been received. If not, the processor 101 determines NO and returns to ACT 4.

Accordingly, the processor 101 waits for one of the execution instruction or the stop instruction to be received in ACT 4 and ACT 5.

The store clerk visually checks the transaction confirmation screen SCA to confirm whether the acquired transaction information is actually for the transaction to be corrected. When the store clerk determines the target transaction is correct, the store clerk instructs the execution of additional operations by tapping the button BUB or the like. If the target transaction is not correct (e.g., does not match the customer receipt in some manner), the store clerk instructs a process stop by tapping the button BUA.

When the operation for instructing a stop is performed, the processor 101 determines YES in ACT 5 and ends the correction processing. On the other hand, when the operation for instructing the execution is performed, the processor 101 determines YES in ACT 4 and the process proceeds to ACT 6.

In ACT 6, the processor 101 performs return processing for all the commodities in the target transaction. That is, all the transaction commodities are at this time treated as being returned (no matter what the specific customer request is at this moment). In association with the transaction data acquired in ACT 2, the processor 101 generates transaction data indicating that the purchases of all the transaction commodities are canceled, and requests the POS server 200 to add this transaction data to the journal file FAA. In response to this request, the processor 201 of the POS server 200 updates the journal file FAA to include the cancellation of the previous transaction. The transaction data related to the cancellation is included in the journal file FAA in association with the previous transaction data (that is, the transaction data for the previous transaction is left in the journal file FAA as it is), which permits the managing of the history of registration (purchase) and cancellation. The processor 101 functions as a cancellation unit in this context.

In ACT 7, the processor 101 performs refund processing. The processor 101 refunds the previous payment amount as represented in the transaction data acquired in ACT 2 by using the previous payment method as represented by the transaction data. For example, when the previous payment method was a cash payment, same amount as the previous payment amount is dispensed from the change unit 112. The processor 101 functions as a refund unit in this context.

In ACT 8, the processor 101 generates new registration data related to performing the correction. The registration data is data representing a commodity list of commodities which are the transaction targets. Here, the processor 101 generates the registration data representing a commodity list including all the transaction commodities included in the transaction data acquired in ACT 2.

FIG. 4 is a diagram schematically illustrating a structure of a data record REA included in registration data.

The registration data includes one or more data records REA. Each data record REA is associated with a commodity (commodity code) that is a transaction target. The data record REA includes fields FAA, FAB, FAC, FAD, and FAE. In the field FAA, a commodity code as an identifier of the associated commodity is set. In the field FAB, a commodity name of the associated commodity is set. In the field FAC, a unit price of the associated commodity is set. In the field FAD, the number of the associated commodities in the transaction is set. In the field FAE, an addition flag indicating whether the associated commodity is a commodity added as the transaction target by the correction is set.

Accordingly, the processor 101 includes a data record REA for each of the transaction commodities that was included in the transaction data acquired in ACT 2 in the registration data generated in ACT 8. The processor 101 sets each piece of information represented in the transaction data acquired in ACT 2 in the fields FAA, FAB, FAC, and FAD of each data record. Furthermore, the processor 101 sets the flags in the field FAE of each data record to a state indicating that none of the associated commodities is an added commodity. Accordingly, when the processor 101 functions as a generation unit in this context.

In ACT 9, the processor 101 displays a registration screen on the store-clerk-side touch panel 104. The registration screen is a screen for allowing the store clerk to confirm the content of the commodity list represented by the registration data. When the registration screen is displayed, the processor 101 may cause the customer-side touch panel 113 to display a screen for allowing the customer to confirm the content of the commodity list represented by the registration data.

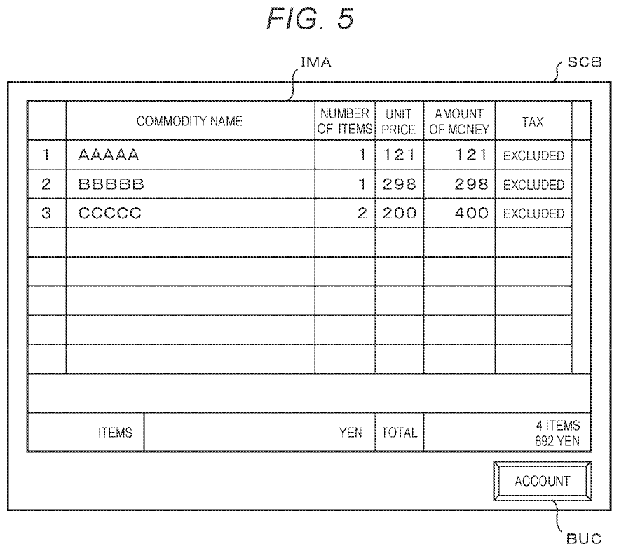

FIG. 5 is a diagram illustrating an example of a registration screen SCB.

The registration screen SCB indicates the image IMA and a button BUC. The image IMA provides details of the content of the target transaction(s). Since the registration data is generated as described above, the same image IMA as that displayed on the transaction confirmation screen SCA can also be displayed on the registration screen SCB initially. The button BUC is a soft key for receiving an instruction to complete the correction and proceed to accounting.

In ACT 10, the processor 101 checks whether there has been an instruction to change/add an item on the commodity list. If not, the processor 101 determines NO and the process proceeds to ACT 11.

In ACT 11, the processor 101 checks whether there has been an instruction to proceed to accounting. If not, the processor 101 determines NO and returns to ACT 10.

Accordingly, the processor 101 waits for a change or accounting instruction to be received in ACT 10 and ACT 11.

The store clerk instructs a change in response to a request from the customer. For example, the store clerk designates a new commodity and adds the new commodity to the commodity list. The store clerk may designate one of the commodities previously included in the commodity list and then instructs cancellation of the purchase of the designated commodity. For The store clerk may change the number of a commodity type on the list. In this context, the store clerk performs the required change operation by using, for example, the store-clerk-side touch panel 104 or the keyboard 105. For example, a dedicated button or key for each change operation type may be provided.

When a change operation instruction is received, the processor 101 determines YES in ACT 10 and the process proceeds to ACT 12.

In ACT 12, the processor 101 updates the registration data according to the change operation instruction. The processor 101 functions as an update unit in this context.

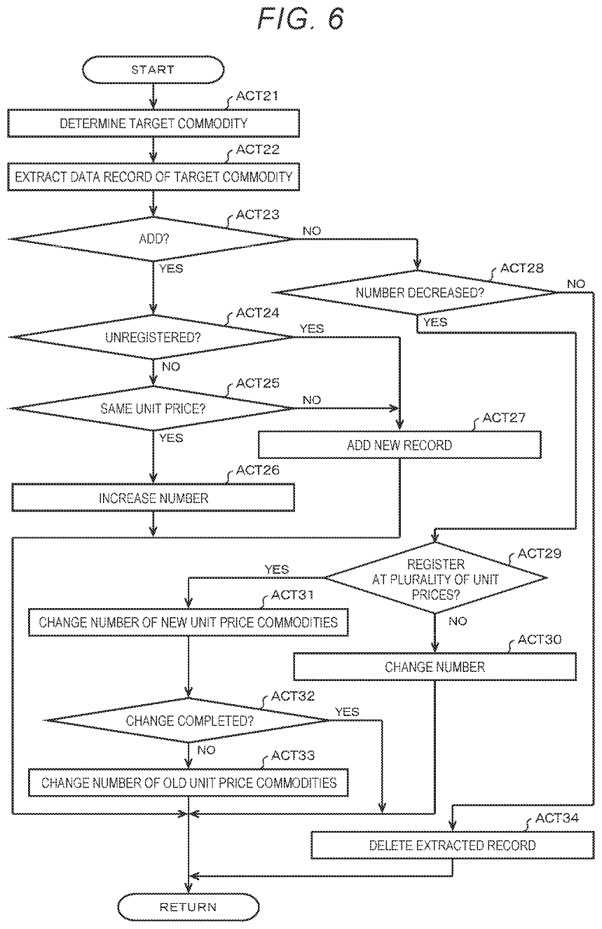

FIG. 6 is a flowchart illustrating a processing procedure for updating the commodity list for a transaction.

In ACT 21, the processor 101 determines a commodity designated is a change target (hereinafter, referred to as a target commodity), for example, by receiving input for the designation from the store clerk.

In ACT 22, the processor 101 attempts to extract the data record REA related to the designated target commodity from the registration data. When there is an instruction to add a commodity, the data record REA related to the target commodity might not be extracted if a commodity of the same type (commodity code) has not been previously registered in the transaction.

In ACT 23, the processor 101 checks whether the instructed change is the addition of a commodity. When there is an instruction to add a commodity, the processor 101 determines YES and the process proceeds to ACT 24. When an increase in the number of a commodity type is requested, the processor 101 also determines YES.

In ACT 24, the processor 101 checks whether the target commodity is unregistered in the registration data. For example, when a corresponding data record REA cannot be extracted in ACT 22, the processor 101 determines that the target commodity is of a type that is unregistered. If the commodity is of the same type (commodity code) of an item already registered in the transaction, the processor 101 determines NO and the process proceeds to ACT 25. That is, if the processor 101 could not find/extract a corresponding data record REA in ACT 22, the process proceeds to ACT 25.

In ACT 25, the processor 101 checks whether the current unit price of the target commodity is the same as the unit price set for the previously registered target commodity. For example, the processor 101 acquires the current unit price of the target commodity from a commodity master table stored in the auxiliary storage unit 103, and confirms whether the unit price is the same as the unit price set in the field FAC of the data record REA extracted in ACT 22. If the unit prices are the same, the processor 101 determines YES and the process proceeds to ACT 26. The processor 101 may request the POS server 200 to acquire the unit price or the information shown in the commodity master table and acquire the information shown in the commodity master table stored in the auxiliary storage unit 203.

In ACT 26, the processor 101 increases the number of the registered target commodity by specified quantity. That is, when there is an instruction to add the commodity, the processor 101 updates the registration data to change a value set in the field FAD of the data record REA extracted in ACT 22 to a value obtained by increasing the number by one. When there is an instruction to increase the number of the target commodities, the processor 101 updates the registration data so as to change the value set in the field FAD of the data record REA extracted in ACT 22 to a value indicating the designated number after the increase.

When the target commodity is previously unregistered, the processor 101 determines YES in ACT 24 and the process proceeds to ACT 27. When the current unit price of the target commodity is different from the unit price set for the registered target commodity, the processor 101 determines NO in ACT 25 and the process proceeds to ACT 27. A case where the unit prices are different from each other may be, for example, a case where the unit price is changed in response to a change in a standard retail price during the period between the past transaction and a present time, or a case where the unit price was temporarily changed at the time of the past transaction or the present time as part of limited time sale promotion period or the like.

In ACT 27, the processor 101 adds a new data record associated with the target commodity to the registration data. For example, the processor 101 acquires a commodity name of the target commodity from the commodity master table stored in the auxiliary storage unit 103. Then, for example, the processor 101 creates the data record REA in which a commodity code of the target commodity, the acquired commodity name, and the unit price acquired in ACT 25 are set in the fields FAA, FAB, and FAC, respectively, “1” is set in the field FAD, and the addition flag indicating that the target commodity is the added commodity is set in the field FAE, and updates the registration data to include the new data record REA. When the processor 101 determines NO in ACT 25 and the process proceeds to ACT 27, after the processor 101 executes ACT 27, a plurality of data records REA in which the commodity code related to the target commodity is set in the field FAA are included in the registration data.

When the instructed change is not an addition of a commodity, the processor 101 determines NO in ACT 23 and the process proceeds to ACT 28.

In ACT 28, the processor 101 checks whether the instructed change is a decrease in the registered number. Then, when there is an instruction to decrease the registered number, the processor 101 determines YES and the process proceeds to ACT 29.

In ACT 29, the processor 101 checks whether the target commodity was registered at different unit prices. When only one data record REA in which the commodity code related to the target commodity is set in the field FAA is included in the registration data, the processor 101 determines NO and the process proceeds to ACT 30.

In ACT 30, the processor 101 changes, according to the instruction, the number set in the field FAD of the data record REA in which the commodity code related to the target commodity is set in the field FAA.

When the plurality of data records REA in which the commodity code related to the target commodity is set in the field FAA are included in the registration data, the processor 101 determines YES in ACT 29 and the process proceeds to ACT 31.

In ACT 31, the processor 101 changes, according to the instruction, the number of the target commodity at the current unit price (hereinafter, referred to as a new unit price commodity). For example, the processor 101 searches the registration data for the data records REA for the commodity code and the addition flag set in the field FAE indicating that the target commodity is an added commodity, and changes, according to the instruction, the number set in the field FAD of the data record REA.

First specific example: when the number of the new unit price commodities is “3” and there is an instruction to change the number of the new unit price commodities to “1”, the processor 101 updates “3” set in the field FAD of the data record REA associated with the new unit price commodity to “1”. Second specific example: when the number of the target commodities that are transaction targets at a unit price different from the current unit price (hereinafter referred to as old unit price commodities) is “3”, and the number of the new unit price commodities is “2”, when there is an instruction to set the number of the old unit price commodities to “2”, the processor 101 updates “2” set in the field FAD of the data record REA associated with the new unit price commodity to “1”. Third specific example: when the number of the old unit price commodities is “3” and the number of the new unit price commodities is “2”, when there is an instruction to set the number of the old unit price commodities to “0”, the processor 101 updates “2” set in the field FAD of the data record REA associated with the new unit price commodity to “0”.

In ACT 32, the processor 101 checks whether the change in the number is completed. For example, in the case of the third specific example described above, if only two are reduced in response to the instruction to reduce the number by three, the change is not completed. When the change in the number as instructed by the change in the number of the new unit price commodities is not completed as described above, the processor 101 determines NO and the process proceeds to ACT 33.

In ACT 33, the processor 101 changes the number of the old unit price commodities by the number which cannot be changed in ACT 31. That is, for example, when the third specific example is executed in ACT 31, the processor 101 updates “3” set in the field FAD of the data record REA associated with the old unit price commodity to “1”.

When there is an instruction to cancel a commodity, the processor 101 determines NO in ACT 23 and ACT 28 and the process proceeds to ACT 34.

In ACT 34, the processor 101 deletes the data record REA extracted in ACT 22 from the registration data.

When the instructed change is completed after ACT 26, ACT 27, ACT 30, ACT 31, ACT 33, or ACT 34, the processor 101 ends the processing of FIG. 6, that is, the processing of ACT 12 in FIG. 2. However, when the change in the number as instructed by the execution of ACT 31 is completed, the processor 101 ends the processing of FIG. 6 only when the processor 101 also determines YES in ACT 32. Then, the processor 101 proceeds to ACT 13 in FIG. 2.

In ACT 13, the processor 101 updates the registration screen to represent content corresponding to the updated registration data. Then, the processor 101 returns to ACT 10 and ACT 11 in the waiting state.

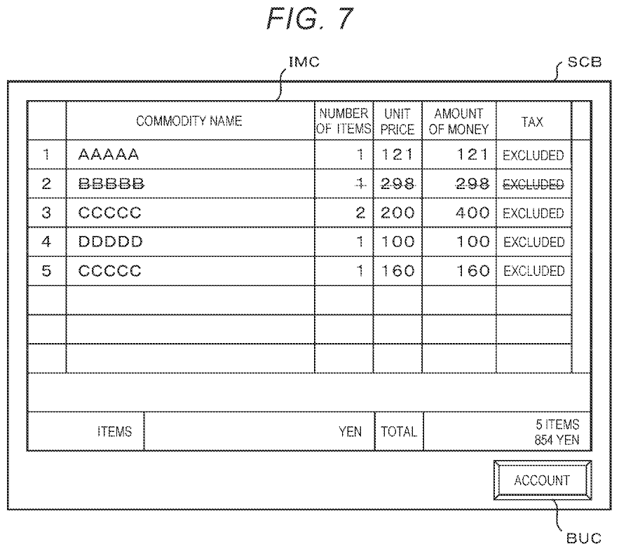

FIG. 7 is a diagram illustrating an example of the updated registration screen SCB.

The registration screen SCB illustrated in FIG. 7 is an example in which the commodity having the commodity name “BBBBB” is cancelled, and one commodity having the commodity name “CCCCC” is added as the new unit price commodity having a unit price of 160 yen from the state where the registration screen SCB illustrated in FIG. 5 is displayed. Accordingly, the registration screen SCB illustrated in FIG. 7 represents an image IMC reflecting the above-described change for the image IMA represented by the registration screen SCB illustrated in FIG. 5.

When the store clerk finishes all the operations for correction according to the requests from the customer, the store clerk instructs to proceed to the accounting by tapping the button BUC on the registration screen SCB. In response to such an instruction, the processor 101 determines YES in ACT 11 in FIG. 2 and the process proceeds to ACT 14.

In ACT 14, the processor 101 executes the accounting processing based on the registration data in the same manner as in a case of the normal registration processing. That is, the processor 101 calculates the price for all the commodities represented by the registration data, and performs processing of settling the prices by a newly designated payment method. In the accounting processing, the processor 101 causes the receipt printer 111 to print a receipt. The processor 101 functions as a payment unit in this context.

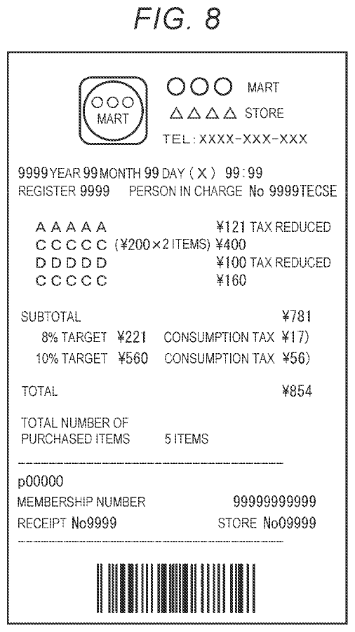

FIG. 8 is a diagram illustrating an example of the receipt.

FIG. 8 illustrates an example when the process proceeds to the accounting processing when the registration screen SCB is in the state illustrated in FIG. 7.

In the receipt, the processor 101 separately represents items having the commodity name “CCCCC” at a unit price of 200 yen and a unit price of 160 yen instead of grouping the items into a single line item.

In ACT 15, the processor 101 transmits transaction data representing the content of the registration data at this time and the result of the accounting processing in ACT 14 to the POS server 200 as data related to a new transaction separate from the transaction identified by the transaction code acquired in ACT 1. The transmission of the transaction data corresponds to a request for the POS server 200 to manage transaction data related to the new transaction separately from the previous transaction. That is, when the processor 101 functions as a request unit. Then, the processor 101 now ends the correction processing.

Upon receiving the new transaction data, the processor 201 of the POS server 200 updates the journal file FAA based on the new transaction data. The processor 201 executes this processing based on the journal management program PRB. When the processor 201 functions as a history management unit.

In this way, the POS terminal device 100 cancels the whole past transaction, which is the correction target, and then accepts the correction operation as a registration of a new transaction incorporating the contents of the past transactions as a starting point. Accordingly, according to the POS terminal device 100, the correction for cancelling a commodity of the past transaction and the correction for adding a new commodity can be performed as one transaction, and a burden on an operator related to the correction of the past transaction can be reduced.

In addition, the POS terminal device 100 separates the data records REA for a commodity having different unit prices at the time of the transaction which is the correction target and when the commodity is corrected. Accordingly, different unit prices can be applied to the same commodity as the target of the past transaction and the newly added commodity, and even a commodity whose unit price is changed can be added without any problem.

In addition, in response to the cancellation of the past transaction, the POS terminal device 100 refunds the total amount of the transaction, and separately settles the newly accepted transaction. As a result, according to the POS terminal device 100, processing can be easily performed without time and effort such as calculating and settling any difference in price that occurs along with the correction.

In addition, after the commodity having the new unit price different from the old unit price is newly added as the transaction target, when there is an instruction to decrease the number of the commodities having the old unit price, the POS terminal device 100 changes the number of the commodities having the new unit price in preference to the number of the commodities having the old unit price. For example, when the commodity having the old unit price higher than the new unit price is newly added by three and the number of commodities having the old unit price is reduced by three, only the unit price is reduced, and such correction is not allowed.

The present embodiments can be modified in various manners such as follows.

The journal file FAA may be stored in the auxiliary storage unit 103. In this case, the processor 101 updates the journal file FAA instead of transmitting the transaction data in ACT 15 in FIG. 2.

A part of the processing executed by the processor 101 described above may be executed by the processor 201 in the POS server 200. For example, ACT 8 and ACT 12 in FIG. 2 may be executed by the processor 201 while using the POS terminal device 100 as a user interface terminal.

The processor 101 may settle the difference between the payment amount related to the past transaction and the payment amount related to the new transaction in ACT 14 without performing refund processing in ACT 7 in FIG. 2.

The processor 101 may change the number of the old unit price commodities when the number of the old unit price commodities is changed.

Some or all of the functions implemented by the processor 101 by the information processing may also be implemented by hardware that executes information processing that is not based on a program such as a logic circuit. The above-described functions may also be implemented by combining software control with the hardware such as the logic circuit described above.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A transaction processing system for improved item return and exchange processing, the system comprising:
a point-of-sale terminal configured to generate transaction data for a customer transaction and perform processing operations related to returns and exchanges; and
a server including:
a storage unit configured to store transaction data for a plurality of previous customer transactions, the transaction data for each previous customer transaction including a list of items included in the customer transaction;
a processor configured to:
select the transaction data of one of the plurality of previous customer transactions in the storage unit based on an input of a transaction identifier from the point-of-sale terminal;
cancel the selected transaction data;
generate registration data corresponding to a new customer transaction, the registration data including the list of items included in the customer transaction corresponding the cancelled selected transaction data;
update the generated registration data according to an operation instruction from the point-of-sale terminal; and
store the updated registration data as new transaction data in the storage unit.

2. The transaction processing system according to claim 1, wherein
the generated registration data includes a unit price of each of the items in the customer transaction, and
when two or more items sharing a same commodity code are in the updated registration data, the unit price for each of the two or more items can be different.

3. The transaction processing system according to claim 1, wherein the processor is further configured to:
issue a refund for a total amount of the cancelled selected transaction data; and
settle a payment amount corresponding to the updated registration data.

4. The transaction processing system according to claim 1, wherein
the point-of-sale terminal includes a printer, and
the printer is configured to print a transaction receipt based on the new transaction data.

5. A transaction processing apparatus for a transaction processing system, the apparatus comprising:
a storage unit storing a journal file including transaction data for previously performed customer transactions, each customer transaction being stored in association with a unique transaction code, the transaction data for each customer transaction including a list of items purchased in the customer transaction and a unit price of each item;
a communication interface connected to a point-of-sale terminal configured to generate transaction data for customer transaction and perform processing operations related to returns and exchanges; and
a processor configured to:
identify a particular previous customer transaction in the journal file based on a transaction code received via the communication interface from the point-of-sale terminal;
upon receiving a return or exchange request from the point-of-sale terminal in association with the transaction code, set the particular previous customer transaction to cancelled in the journal file and generate transaction data for a new customer transaction, the transaction data for the new customer transaction initially including the list of items and unit prices in the transaction data of the previous customer transaction; and
based on the return or exchange request, update the transaction data for the new customer transaction to reflect a return or exchange of an item purchased in the previous customer transaction.

6. The transaction processing apparatus according to claim 5, wherein the processor is further configured to:
issue a refund for a total amount of the previous customer transaction; and
settle a payment amount corresponding to the updated transaction data for the new customer transaction.

7. The transaction processing apparatus according to claim 5, wherein, when two or more items sharing a same commodity code are in the updated transaction data for the new customer transaction, the unit price for each of the two or more items can be different.

8. The transaction processing apparatus according to claim 5, wherein the processor is further configured to:
settle a payment amount corresponding to the updated transaction data for the new customer transaction by offsetting the total amount due in the new customer transaction by the total amount paid in the previous customer transaction.

9. The transaction processing apparatus according to claim 8, wherein the processor is configured to add an item to a list of items in the transaction data for the new customer transaction based on a registration input of a commodity code of the added item at the point-of-sale terminal.

10. The transaction processing apparatus according to claim 5, wherein the processor is configured to add an item to a list of items in the transaction data for the new customer transaction based on a registration input of a commodity code of the added item at the point-of-sale terminal.

11. The transaction processing apparatus according to claim 10, wherein, when two or more items sharing a same commodity code are in the updated transaction data for the new customer transaction, the unit price for each of the two or more items can be different.

12. A non-transitory, computer-readable medium storing program instructions which when executed by a processor of a transaction processing apparatus in a transaction processing system for retail stores causes the apparatus to perform a method comprising:
select transaction data of one of a plurality of previous customer transactions in a storage unit based on an input of a transaction identifier from a point-of-sale terminal;
cancel the selected transaction data;
generate registration data corresponding to a new customer transaction, the registration data including the list of items included in the customer transaction corresponding the cancelled selected transaction data;
update the generated registration data according to an operation instruction from the point-of-sale terminal; and
store the updated registration data as new transaction data in the storage unit.

13. The non-transitory, computer-readable medium according to claim 12, wherein
the generated registration data includes a unit price of each of the items in the customer transaction, and
when two or more items sharing a same commodity code are in the updated registration data, the unit price for each of the two or more items can be different.

14. The non-transitory, computer-readable medium according to claim 13, wherein the method further comprises:
issue a refund for a total amount of the cancelled selected transaction data; and
settle a payment amount corresponding to the updated registration data.

15. The non-transitory, computer-readable medium according to claim 12, wherein the method further comprises:
issue a refund for a total amount of the cancelled selected transaction data; and
settle a payment amount corresponding to the updated registration data.
